(19) United States
(12) Patent Application Publication
(10) Pub. No.: US 2004/0036273 A1
(43) Pub. Date: Feb. 26, 2004

(54) Methods and apparatus for determining integrity of interconnections

(76) Inventor: Charles R. McClary, Spring Lake Park, MN (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/224,926

(22) Filed: Aug. 20, 2002

(51) Int. Cl. F16L 55/00

(52) U.S. Cl. 285/18; 285/93

(57) ABSTRACT

A connection assembly is described which includes a first connector, a second connector, a sensor and an actuator. The second connector is configured to mate with the first connector and the sensor is mounted in proximity to the first connector. The actuator for the sensor is mounted in proximity to the second connector, and is positioned with respect to the second connector so as to align with and actuate the sensor when the first connector and the second connector are properly aligned and connected. The sensor is configured to supply a signal which indicates whether or not the connectors are properly aligned and connected.

### BACKGROUND OF THE INVENTION

This invention relates generally to determination of proper connections between multiple devices, and more specifically to, the determination of the integrity of interconnections between two or more devices.

It is important to know if interconnections between devices have been properly made, for example, between pressure lines, or electrical connectors. The integrity of the connections are important since measurements made by sensors need to be received by another system. Such measurements are typically one basis for control of an overall system, for example, flight control of an aircraft.

In some circumstances, unsafe conditions arise if faulty connections between multiple devices are undetected. This is especially true in redundant systems which make decisions based on comparison monitoring. For example, if one of three pressure lines is properly connected, and two of the three are not properly connected, then an erroneous output of the two unconnected pressure lines may be selected over the correct output. A single fault may be indicated faulting the one pressure line connection that was installed properly. Such a situation can be hazardous and undesirable. Although heretofore described as being related to pressure lines, the same conditions can result in other systems.

### BRIEF SUMMARY OF THE INVENTION

In one aspect, a connection assembly is provided which comprises a first connector, a second connector configured to mate with the first connector, a sensor mounted in proximity to the first connector, and an actuator for said sensor. The actuator is mounted in proximity to the second connector, and positioned with respect to the second connector so as to align with and actuate the sensor when the first connector and the second connector are properly aligned and connected. The sensor is configured to supply a signal which indicates whether or not the first connector and the second connector are properly aligned and connected.

In another aspect, a method for ensuring a first connector and a second connector are properly connected is provided, the connection of the first connector and the second connector being needed for operation of a system. A sensor is mounted in proximity to one of the connectors and an actuator for the sensor is mounted on the other connector. The method comprises connecting the first connector to the second connector, aligning the sensor and the actuator, and receiving a signal from the sensor which indicates that the sensor and the actuator are aligned, which indicates a proper connection between the first connector and the second connector. The method further comprises enabling operation of the system upon receipt of the signal.

In still another aspect, a connector is provided which comprises a body, at least one of a sensor and an actuator, and a protrusion from the body. The protrusion is configured for mounting at least one of the sensor and the actuator.

In yet another aspect, a mounting assembly for a connector is provided which comprises a connector mounting surface and a sensor mounting surface. The connector mounting surface comprises one or more holes therethrough for mounting the connector and the sensor mounting surface comprises one or more holes therethrough for mounting of a sensor or an actuator. The sensor mounting surface is positioned with respect to the connector mounting surface such that when a first connector with an actuator mounted thereon is connected to a second connector mounted on the connector mounting surface, a sensor mounted on the sensor mounting surface is aligned with the actuator.

### BRIEF DESCRIPTION OF THE DRAWINGS

FIG. 1 is a diagram of a connection assembly which incorporates a sensor and an actuator.

FIG. 2 is a diagram of a connector having a sensor mounted thereon.

FIG. 3 is a diagram of a connector which mates to the connector of FIG. 2 and which has an actuator mounted thereon.

FIG. 4 is a diagram of a system which utilizes a sensor and an actuator to verify integrity of a connection between connectors.

### DETAILED DESCRIPTION OF THE INVENTION

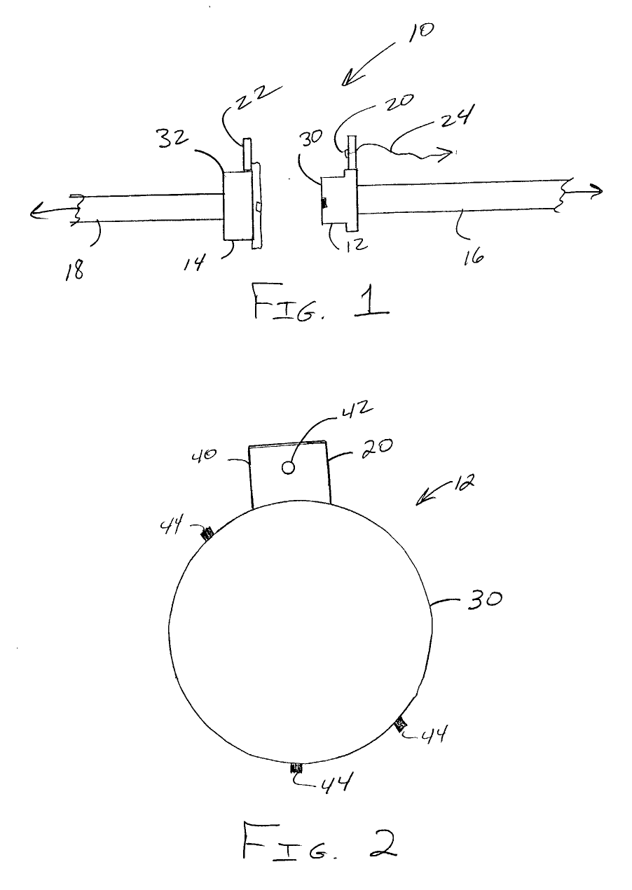

FIG. 1 is a diagram of a connection assembly 10. Connection assembly 10 includes a first connector 12 and a second connector 14 which is configured to mate with first connector 12. Connectors 12 and 14 provide connection between a first line 16 and a second line 18. Lines 16 and 18 are contemplated to include any type of medium for which a coupling or other type of connection might be utilized. Therefore lines 16 and 18 include, but are not limited to, pressure lines, fluid lines, electrical signal lines, and vacuum lines. For simplicity, references herein are made with respect to pressure lines.

Connection assembly 10 further includes a sensor 20 which is mounted in proximity to first connector 12, and an actuator 22 for sensor 20. Actuator 22 is mounted in proximity to second connector 14, and is positioned with respect to second connector 14 so as to align with and actuate sensor 20 when first connector 12 and second connector 14 are properly aligned and connected. Sensor 20 is configured to supply a signal 24 which indicates whether or not first connector 12 and second connector 14 are properly aligned and connected.

In one embodiment, sensor 20 is a proximity sensor. Alternative embodiments of proximity sensors include, but are not limited to, a capacitive sensor, an inductive sensor, a hall effect sensor, a photoelectric sensor, an ultrasonic sensor, a radio frequency sensor, a laser sensor, a fiber optic sensor, an eddy current sensor, a variable reluctance sensor, and a magneto resistive sensor.

Alternative embodiments of sensor 20 typically utilize some type of actuator 22. In the embodiment where sensor 20 is a hall effect proximity sensor, actuator 22 is a magnetic material. In another embodiment, where sensor 20 is a capacitive proximity sensor, actuator 22 is a non-magnetic material, for example, wood, plastic, or glass.

In another alternative embodiment, actuator 22 is an active device. In the embodiment, sensor 20 is a photoelectric sensor and actuator 22 is an infrared light source. Other embodiments of photoelectric sensors and infrared light sources may be implemented. For example, in another alternative embodiment, sensor 20 includes a photoelectric sensor and an infrared light source and actuator 22 is a reflective material. In that embodiment, when connector 12 and connector 14 are properly connected and aligned, light from the infrared light source is reflected back from actuator 22 to the photoelectric sensor, which outputs indication signal 24.

In yet another alternative embodiment, sensor 20 is a fiber optic sensor and actuator 22 is a fiber optic light source. In still another alternative embodiment, sensor 20 is a laser sensor and actuator 22 is a laser light source. In another embodiment, sensor 20 is a radio frequency receiver and actuator 22 is a radio frequency signal source. The particular sensor and actuator technologies utilized is chosen based upon the circumstances of a specific application. For example, a laser or fiber optic sensor and actuator setup may not be the best choice for verifying integrity of fluid line connections, since any spilled or leaking fluids may cause light from the light source to become scattered, and may keep the light from illuminating or impinging upon sensor 22, even if the connectors are properly aligned and connected. For a fluid line connection, a hall effect proximity sensor may be a better choice.

Many types of connectors exist, and replacement of existing connectors may not always be practical. Therefore, in one embodiment, sensor 20 is a discrete part mounted to protrude from body 30 of connector 12 and actuator 22 is a discrete part mounted to protrude from body 32 of connector 14. In another embodiment, sensor 20 and actuator 22 are molded as a part of body 30 or body 32, respectively. An alternative arrangement for placement of at least one of sensor 20 and actuator 22 is described below with respect to FIG. 4. In a further embodiment, a sensor 20 is mounted to an existing connector 12 and is actuated by connector 14, upon a proper connection between the two, and without the addition of a specific actuator thereto.

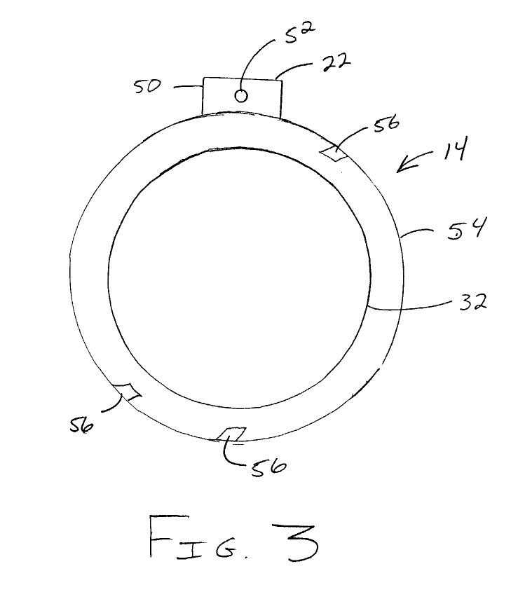

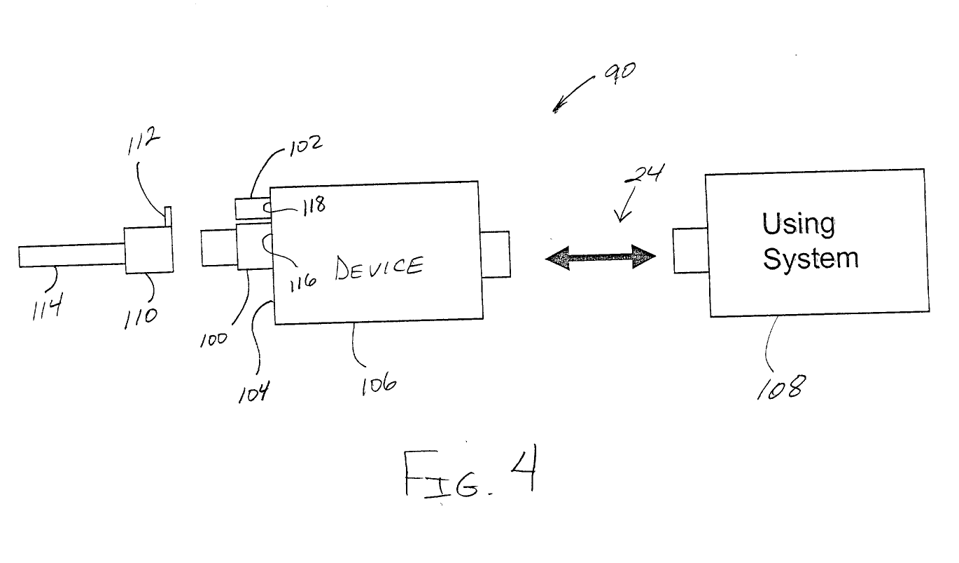

FIG. 2 is a diagram of connector 12 including a body 30 and a protrusion 40 from body 30, either molded or attached, as described above. Protrusion 40 allows for mounting one of a sensing device 20 and an actuating device. For simplicity, a combination of protrusion 40 and sensing device 42 are collectively referred to herein as sensor 20. For illustrative purposes, a number of guide pins 44 are shown as protruding from body 30 of connector 12. Guide pins 44 are utilized in aligning certain connector pairs as is further described with respect to FIG. 3 below.

FIG. 3 is a diagram of connector 14 including a body 32 and a protrusion 50 extending from body 32, either molded or attached, as described above. Protrusion 50 allows for mounting one of a sensing device and an actuating device 52. For simplicity, a combination of protrusion 50 and actuating device 52 are collectively, referred to herein as actuator 22. Connector 14 also includes a rotatable sleeve 54. For illustrative purposes, a number of guide slots 56 are shown as being molded into rotatable sleeve 54. Guide slots 56 are configured to engage guide pins 44 (shown in FIG. 2) as connector 12 and connector 14 are engaged. Rotatable sleeve 54 is then rotated, further engaging guide pins 44, and includes a locking mechanism (not shown) which holds connectors 12 and 14 in place. As known in the art, guide slots 56 will not engage guide pins 44 if connector 12 and connector 14 are not properly aligned. In an alternative embodiment (not shown), actuator 22 is mounted on rotatable sleeve 54, and aligns with sensor 20 at a point where rotatable sleeve 54 no longer will rotate (i.e. the locking mechanism is engaged), which signifies that connector 12 and connector 14 are fully engaged.

The connector example of FIGS. 2 and 3 are illustrative only. Many other types of connector engaging and locking mechanisms are contemplated, as well known in the art. Other non-limiting examples include connectors which are engaged to one another via a threaded coupling or a push and click type coupling as is commonly used to connect compressed air lines.

FIG. 4 is a diagram of a system 90 which utilizes a sensor and an actuator to verify integrity of a connection between connectors. System 90 utilizes the sensor and actuator operation as described above, but where the sensor or actuator is not necessarily attached to a body of a connector. Referring to FIG. 4, a first connector 100 and a sensor 102 arc mounted to a mounting surface 104 of device 106. Device 106 internally routes signal 24 (also shown in FIG. 1) from sensor 102, and eventually outputs signal 24 to a using system 108. In one exemplary embodiment, using system 108 incorporates a software program running on a processor (not shown) which attempts to verify a status of signal 24. A status of signal 24 verifies whether or not connector 100 is aligned with and properly connected to connector 110. Connector 110 incorporates an actuator 112, which is equivalent to one of the embodiments of actuator 22, described above. Of course, alternative embodiments exist where actuator 112 is mounted to mounting surface 104 and sensor 102 is mounted to connector 110. Such alternative embodiments depend on the application and what medium (i.e. fluid, pressure, electrical signals) is being transferred through line 114.

Mounting surface 104 provides a mounting assembly for connector 100 and sensor 102 having a connector mounting surface 116 which has one or more holes (not shown) therethrough for mounting connector 100. Mounting surface 104 further includes a sensor mounting surface 118 which has one or more holes therethrough for mounting of sensor 102 (or actuator 112). Sensor mounting surface 118 is positioned with respect to connector mounting surface 116 such that when connector 110 with actuator 112 mounted thereon is connected to connector 100 mounted on connector mounting surface 116, sensor 102 mounted on sensor mounting surface 118 is aligned with actuator 112.

The embodiments described with respect to FIG. 4 provide methods for ensuring a first connector and a second connector are properly connected, as a sensor is mounted in proximity to one of the connectors and an actuator for the sensor being mounted in proximity to the other connector. Such a method includes connecting the first connector to the second connector and receiving a signal from the sensor which indicates a proper connection between the first connector and the second connector. The method is adaptable to multiple connector types including connector types where connecting the first connector to the second connector includes pushing the first connector into the second connector until a connection is made. The method is further adaptable to connectors where one of the connectors includes a rotatable sleeve, and where one of the sensor or the actuator is mounted on the sleeve, the rotatable sleeve being rotated until the sensor and the actuator are aligned.

The embodiments herein described also provide methods for ensuring a first connector and a second connector, neither of which are mounted to a mounting device, are properly connected. One connector includes a body and a rotating locking device (i.e. rotatable sleeve) mounted to the body where the rotating locking device has one of the sensor and actuator mounted thereon. The other connector includes a body which includes the other of the sensor and the actuator and engaging portions or protrusions that engage the rotating locking device. To connect the first connector to the second connector a user turns the rotating locking device until the first connector is engaged with the second connector, causing the sensor and actuator to align. The described methods are, of course, applicable to connector types other than rotating and locking type connectors, as described above.

A sensing system including a sensor and actuator arrangement to determine if the connectors are properly connected is invaluable in an attempt to alleviate hazards that can occur in manufacturing application and in moving vehicles. The detection of a proper connection can therefore be transmitted, through one or more enabling signals, to a using system or systems to enable operation of such a system. Also, the lack of an enabling signal can be used to disable the using system and trigger an alarm, notifying personnel that one or more connections need to be corrected.

While the invention has been described in terms of various specific embodiments, those skilled in the art will recognize that the invention can be practiced with modification within the spirit and scope of the claims.

What is claimed is:

1. A connection assembly comprising:
a first connector;
a second connector configured to mate with said first connector;
a sensor mounted in proximity to said first connector; and
an actuator for said sensor, said actuator mounted in proximity to said second connector, and positioned with respect to said second connector so as to actuate said sensor when said first connector and said second connector are properly aligned and connected, said sensor configured to supply a signal which indicates whether or not said first connector and said second connector are properly aligned and connected.

2. A connection assembly according to claim 1 wherein said first connector and said second connector comprise at least one of pressure lines connectors, fluid line connectors, vacuum line connectors, and electrical connectors.

3. A connection assembly according to claim 1 wherein said sensor comprises a proximity sensor, said proximity sensor being one of capacitive, inductive, hall effect, photoelectric, ultrasonic, radio frequency, laser, fiber optic, eddy current, variable reluctance, and magneto resistive.

4. A connection assembly according to claim 1 wherein said sensor comprises a hall effect proximity sensor and said actuator comprises a magnetic material.

5. A connection assembly according to claim 1 wherein said sensor comprises a capacitive proximity sensor and said actuator comprises a non-magnetic material.

6. A connection assembly according to claim 1 wherein said sensor comprises a photoelectric sensor and said actuator comprises an infrared light source.

7. A connection assembly according to claim 1 wherein said sensor comprises a photoelectric sensor and an infrared light source and said actuator comprises a reflective material.

8. A connection assembly according to claim 1 wherein said sensor comprises a fiber optic sensor and said actuator comprises a fiber optic light source.

9. A connection assembly according to claim 1 wherein said sensor comprises a laser sensor and said actuator comprises a laser light source.

10. A connection assembly according to claim 1 wherein said sensor comprises a radio frequency receiver and said actuator comprises a radio frequency signal source.

11. A connection assembly according to claim 1 wherein said sensor is mounted to said first connector.

12. A connection assembly according to claim 1 wherein said first connector and said sensor are mounted to a mounting surface.

13. A connection assembly according to claim 1 wherein said actuator is mounted to said second connector.

14. A connection assembly according to claim 1 wherein said second connector and said actuator arc mounted to a mounting surface.

15. A method for ensuring a first connector and a second connector are properly connected, the connection of the first connector and the second connector being needed for operation of a system, a sensor being mounted in proximity to one of the connectors and an actuator for the sensor being mounted in proximity to the other connector, said method comprising:
connecting the first connector to the second connector;
aligning the sensor and the actuator; and
receiving a signal from the sensor which indicates the sensor and the actuator are aligned, which indicates a proper connection between the first connector and the second connector; and
enabling operation of the system upon receipt of the signal.

16. A method according to claim 15 wherein connecting the first connector to the second connector comprises pushing the first connector into the second connector until a connection is made.

17. A method according to claim 16 wherein one of the connectors includes a rotatable sleeve, one of the sensor or the actuator mounted on the sleeve, said method further comprising rotating the rotatable sleeve until the sensor and the actuator are aligned.

18. A method according to claim 15 wherein one connector includes a body and a rotating locking device mounted to the body, the rotating locking device having one of the sensor and actuator mounted thereon, the other connector including a body which includes the other of the sensor and the actuator and engaging portions to engage the rotating locking device, said connecting the first connector to the second connector comprises turning the rotating locking device until the first connector is engaged with the second connector.

19. A method according to claim 18 wherein turning the rotating locking device causes the sensor and the actuator to align.

20. A connector comprising:
a body;
at least one a sensor and an actuator; and
a protrusion from said body, said protrusion configured for mounting at least one of said sensor and said actuator.

21. A connector according to claim 20 wherein said protrusion is one of molded as a part of said body or a discrete part attached to said body.

22. A mounting assembly for a connector comprising:
a connector mounting surface comprising one or more holes therethrough for mounting the connector; and
a sensor mounting surface comprising one or more holes therethrough for mounting of a sensor or an actuator, said sensor mounting surface positioned with respect to said connector mounting surface such that when a first connector with an actuator mounted thereon is connected to a second connector mounted on said connector mounting surface, a sensor mounted on said sensor mounting surface is aligned with the actuator.
